(19) United States
(12) Patent Application Publication
(10) Pub. No.: US 2025/0205719 A1
(43) Pub. Date: Jun. 26, 2025

(54) ATTACHMENTS FOR WORK TOOLS INCLUDING AN OPERATING GUN AND A TRIGGER

(71) Applicant: Alamo Group Inc., Seguin, TX (US)

(72) Inventor: Jason David Hetcher, Mukwonago, WI (US)

(21) Appl. No.: 18/395,061

(22) Filed: Dec. 22, 2023

(51) Int. Cl. B05B 9/01; B05B 15/63

(52) U.S. Cl. CPC B05B 9/01; B05B 15/63

(57) ABSTRACT

In some embodiments, an attachment for a work tool having a handle and a trigger adjustable between an on-position and an off-position may include a clip. The clip may include a first arm and a second arm extending from a link, the clip being configured so that the first arm and the second arm are separated by a width suitable for holding the trigger in its on-position, with the first arm abutted against an external surface of the handle and the second arm abutted against the trigger. The clip may include an exterior grasping surface. In some embodiments, the clip may be configured to automatically disengage from the handle when a worker is not grasping over the clip. In some embodiments, the clip may be used with a tether. Work tools and gloves including such attachments are also disclosed.

### CROSS REFERENCE TO RELATED APPLICATIONS

None.

### FIELD

This disclosure relates to attachments for work tools or equipment, such as power washers, of the type including an operating gun and a trigger.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Some work tools may be equipped with an operating gun and a trigger. For example, power washers may be used to provide a high velocity stream of fluid which can be dangerous if inappropriately directed. Accordingly, power washers are commonly provided with a pressure gun including a safety-lock valve to reduce the risk of injury. When using a power washer or similarly equipped work tool with an operating trigger, a user may need to continuously squeeze the trigger, such as a lever, so as to open the safety-lock valve. In the absence of this squeezing force, the safety-lock valve is biased to a closed position. The process of continuously squeezing the trigger may become tiresome particularly in situations wherein the tool is used for extended periods of time. It would be advantageous to provide an attachment configured for squeezing the trigger so that a user is not required to manually provide at least the full force necessary to activate the trigger. It would also be beneficial to provide a safety mechanism to automatically disengage the attachment from the trigger if the user drops or loses control of the operating gun.

### SUMMARY

In some embodiments, an attachment for a work tool having a handle and a trigger adjustable between an on-position and an off-position may include a clip having a first arm and a second arm extending from a link. The clip may be configured so that the first arm and the second arm delineate a width suitable for holding the trigger in its on-position, with the first arm abutted against an external surface of the handle and the second arm abutted against the trigger, when the clip is engaged with the handle. The clip may include an exterior surface configured for manual grasping by a worker when the clip is engaged with the handle of the work tool.

In some embodiments, an attachment for a work tool having a handle and a trigger adjustable between an on-position and an off-position may include a clip. The clip may include a generally C-shaped or a generally U-shaped profile and a thin portion configured to wrap about at least a portion of the handle, the clip being configured for holding the trigger in its on-position when the clip is engaged with the handle, the thin portion characterized by a thickness that is substantially less than a length of the profile. The clip may include an exterior surface configured for manual grasping by a worker when the clip is engaged with the handle of the work tool.

In some embodiments, an attachment for a work tool having a handle and a trigger adjustable between an on-position and an off-position may include a clip and a tether. The clip may include a first arm and a second arm extending from a link, the clip being configured so that said first arm and said second arm are separated by a width suitable for holding the trigger in its on-position, with the first arm abutted against an external surface of the handle and the second arm abutted against the trigger, when the clip is engaged with the handle. The link may include a first curved bend, a second curved bend, and a central portion, the first curved bend connecting the first arm to the link and the second curved bend connecting the second arm to the link. The clip may include an exterior surface configured for manual grasping by a worker when the clip is engaged with the handle of the work tool. The tether may be secured to the clip. The tether may include a strap including a loop portion configured for securing the tether to a hand or a wrist of the worker.

In some embodiments, a work tool may include a handle including a trigger for controlling a safety interlock, the trigger being adjustable between an on-position and an off-position. The work tool may also include a clip including a first arm and a second arm extending from a link, the clip being configured so that the first arm and the second arm are separated by a width suitable for holding the trigger in its on-position, with the first arm abutted against an external surface of the handle and the second arm abutted against the trigger, when the clip is engaged with the handle. The clip may include an exterior surface configured for manual grasping by a worker when the clip is engaged with the handle of the work tool.

In some embodiments, a glove may be configured for use with a work tool having a handle and a trigger adjustable between an on-position and an off-position. The glove may include a glove body shaped for fitting over a hand of a worker and a clip. The clip may be secured to the body of the glove, the clip including a first arm and a second arm extending from a link, the first arm and the second arm configured for holding the trigger in its on-position with the first arm abutted against an external surface of the handle and the second arm abutted against the trigger. The clip may include an exterior surface configured for manual grasping by a worker when the clip is engaged with the handle of the work tool.

In some embodiments, an attachment for a work tool having a handle and a trigger adjustable between an on-position and an off-position may include a clip and a strap configured for securing the clip to a hand or wrist of a worker. The clip may include a first arm and a second arm extending from a link, the first arm and the second arm configured for holding the trigger in its on-position with the first arm abutted against an external surface of the handle and the second arm abutted against the trigger. The clip may include an exterior surface configured for manual grasping by a worker when the clip is engaged with the handle of the work tool.

In some embodiments, a work tool may include a handle including a trigger for controlling an operational mode of a work tool, the trigger being adjustable between a first position and a second position. The work tool may also include a clip including a first arm and a second arm extending from a link, the clip being configured so that the first arm and the second arm are separated by a width suitable for holding the trigger in its first position, with the first arm abutted against an external surface of the handle and the second arm abutted against the trigger, when the clip is engaged with the handle. The clip may include an exterior surface configured for manual grasping by a worker when the clip is engaged with the handle of the work tool.

It is an objective of some embodiments herein to provide attachments for work tools (e.g., power washers, hand-held drills, rotary-jack hammers, or power saws) that may include a clip that readily disengages from the work tool's handle and associated trigger in the event that a worker loses control of the work tool's handle. For example, in some embodiments, a clip may be only loosely engaged with a work tool's handle or otherwise configured so that the clip orients to a position wherein it readily disengages from the handle if a worker is not actively grasping over a handle-engaged clip. In some embodiments, the attachment may be configured so that the clip will not inadvertently catch on the work tool's handle while disengaging from the handle, which is a situation that could inadvertently direct the work tool upwards or in an uncontrolled direction creating safety risk to the worker or others.

In some embodiments herein, an attachment may include a clip configured for securely holding a trigger in an on-position when the clip is positioned over a power-washer gun's handle and associated trigger. The clip may be loosely engaged when positioned over a power-washer gun's handle and associated trigger. In some such embodiments, a user may be required to position at least a part of their hand over at least a part of the clip so that the clip is supported by the user and thereby reliably maintained in a working position engaged with the power-washer gun's handle and associated trigger. For example, in the absence of support by a user, at least one of the arms of a resilient clip may tend to bend so as to allow the clip to easily disengage from the power-washer's handle and trigger.

In some embodiments, a clip may be loosely attached when positioned over a power-washer gun's handle and associated trigger. To help ensure that the loosely attached clip quickly disengages from the trigger in the event that a user loses control of the power washer or drops the power-washer gun, a tether may be secured to the clip. The tether may further be secured to the user's body, such as by securing the tether to the user's hand or wrist, for example. Accordingly, the weight of an unsupported or dropped power washer gun will pull on the tether secured clip so that the clip reliably disengages from the power-washer gun's handle and associated trigger.

### BRIEF DESCRIPTION OF THE DRAWINGS

FIG. 1 is a perspective view of an exemplary embodiment of an attachment including a clip and a tether.

FIG. 2 is a perspective view of the attachment shown in FIG. 1 shown with the clip secured to the handle of a power-washer gun and tethered to a user's wrist or hand.

FIG. 3 is a perspective view of the attachment shown in FIG. 1 shown with the clip engaged with the handle of an item of work equipment and with a user grasping the handle.

FIG. 4 is a perspective view of an exemplary embodiment of a clip.

FIG. 5 is a side elevational view of the clip shown in FIG. 4.

FIG. 6 is a back elevational view of the clip shown in FIG. 4.

FIG. 7 is a front elevational view of the clip shown in FIG. 4.

FIG. 8 is a side elevational view of an exemplary embodiment of a tether including an adjustable connector.

FIG. 9 is a front elevation view of an exemplary embodiment of the adjustable connector shown in FIG. 8.

FIG. 10 is a side elevational view of an exemplary embodiment of a clip including a pair of nubs.

FIG. 11 is a side elevational view of another exemplary embodiment of a clip shown in a configuration wherein the arms of the clip are not engaged with a handle of a piece of work equipment.

FIG. 12 is a side elevational view of the clip shown in FIG. 11 wherein the clip is shown in a distorted configuration as may be found when the clip is engaged with the handle of a piece of work equipment and bent.

FIG. 13 is a side elevational view of an exemplary embodiment of a fold as may be formed at one or more ends of a clip.

FIG. 14 is a perspective view of an exemplary embodiment of an attachment including a clip and a strap configured for securing the clip about a worker's hand or wrist.

FIG. 15 is a perspective view of an exemplary embodiment of an attachment including a clip integrated into or attached to a glove.

FIG. 16 is a side elevational view of an exemplary embodiment of a clip wherein an arm is configured to extend around the handle of a piece of work equipment.

FIG. 17 is a side elevational view of an exemplary embodiment of a clip including an outer surface that is shaped for manual gripping.

FIG. 18 is a back elevational view of the clip shown in FIG. 17.

### DETAILED DESCRIPTION

As used herein, the following terms should be understood to have the indicated meanings:

When an item is introduced by “a” or “an,” it should be understood to mean one or more of that item.

“Comprises” means includes but is not limited to.

“Comprising” means including but not limited to.

“Having” means including but not limited to.

This disclosure is directed to attachments for work tools of the type including an operating gun and a trigger. A trigger may, for example, be operably engaged with a safety interlock of a work tool or otherwise configured for controlling an operational mode of a work tool. For example, in the case of a pressure washer, movement of the trigger between a first position and a second position may cause the tool to switch between an “off” mode in which water or other fluid is not discharged from the gun and an “on” mode in which water or other fluid is discharged from the gun. Of course, a trigger may also be configured to control other operational modes of various types of work tools. For example, power washers may include a power-washer gun (sometimes referred to as a pressure gun) including a handle and an associated trigger. The trigger may be formed as part of the handle so that it may be engaged by a worker when the worker grasps the power-washer gun's handle. Other examples of work equipment or tools which may include an operating gun and a trigger include hand-held drills, rotary-jack hammers, hand-held saws, and spray guns. In some embodiments, the attachments as described herein may include a clip and a tether. Clips as described herein may be configured to make it easier for a user to activate a trigger on the handle of a work tool. For example, by automatically holding the trigger of a power-washer gun in an on-position, a clip may help to alleviate strain in a user's hand that may otherwise develop if a user were forced to manually hold the trigger in its on-position for extended periods of time.

In some embodiments, a clip may be configured to fit around the handle of a work tool and hold the handle's trigger in an on-position without interfering with a user's ability to comfortably grasp the handle. For example, in some embodiments, a clip may be comprised of a sheet of metal or other suitable material that wraps about at least a portion of a work tool's handle. The clip may be thin so that it does not substantially protrude from the handle or substantially change the effective size of the handle when a user grasps the handle around the clip. This may be compared with some other clips including, for example, some that may be used with gasoline pumps. Those clips may protrude outwards from the pump's handle and are not configured so that a user may grasp over the clip-mounted handle.

In some embodiments, attachments described herein may be adjustable so that they may easily accommodate users with slightly different grips or with different sized hands and/or wrists. Tethers may, for example, include an adjustable connector configured to allow for adjustment of the length of different portions of the tether, including, for example, a connecting portion of a tether and a loop portion of the tether. The loop portion of the tether may be configured for securing the tether to a user's body by fitting the loop portion of the tether over the user's hand or wrist, for example. The connecting portion of the tether may provide a length of a material used for connecting the loop portion of the tether to a clip.

In some embodiments, attachments for work tools as described herein may be configured so that a clip will automatically disengage from a position holding the work tool's trigger in an on-position under one or more conditions. For example, in some embodiments, attachments as described herein may be configured to automatically disengage from a position holding the trigger in an on-position if the clip is pulled by a tether. For example, a tether may be secured to the clip at one end and secured to the patient's body at a second end. In the event that the user loses control of the work tool's handle or drops the work tool, the tether will pull on the clip so that it disengages from the handle and its associated trigger allowing for deactivation of the work tool using its own safety interlock.

In some embodiments, a clip may be configured so that it may easily disengage from a work tool's handle and its associated trigger in the absence of support from a user. For example, an attachment may comprise a resilient clip which, in the absence of support by the user's hand, may bend (e.g., being biased to revert back to an undeflected condition) so as to adopt a relaxed configuration wherein it may easily slide off of a power-washer gun's handle (or handle of another type of work tool) and automatically disengage from its associated trigger. A user may grasp over the clip in a deflected condition wherein the clip is engaged with the tool's handle and trigger so as to support the clip and keep it from adopting an undeflected configuration wherein it will easily slide off from the handle.

The above mechanisms for initiating disengagement of a clip from a handle are not mutually exclusive. For example, in some embodiments, a clip may be resilient so that the clip may bend under a biasing force provided by the trigger and adopt a configuration wherein it may easily slide off from a work tool's handle in the event that a worker loses control of the handle. The clip may further be tethered to the worker's hand or wrist so that the clip may be pulled by the tether at about the same time that the clip is relaxed so as to provide for disengagement more easily from the handle. Notably, because workers may comfortably grasp over handle-engaged clips during extended use, clips as described herein may, in some embodiments, be used with or without a tether yet still automatically activate a work tool's safety interlock should the worker lose control of the work tool. This may be contrasted with other clips that may hold a trigger in an activated position when engaged with a handle but are not designed for a worker to grasp over a clip when it is engaged with the handle.

In some embodiments, a clip may be engaged with a handle of a work tool and its associated trigger. The clip may provide the entire force necessary to depress the trigger so as to activate the trigger and keep the trigger in its on-position. Therefore, a user may not need to provide a manual force to activate the trigger. In other embodiments, a clip may be engaged with a handle of a work tool and its associated trigger. However, the clip may provide only a portion of the total force necessary to depress the trigger so as to activate the trigger and keep the trigger in its on-position. Therefore, a user may be required to grasp over the clip and apply at least some of the total force required to depress the trigger so as to activate the trigger and keep the trigger in its on-position.

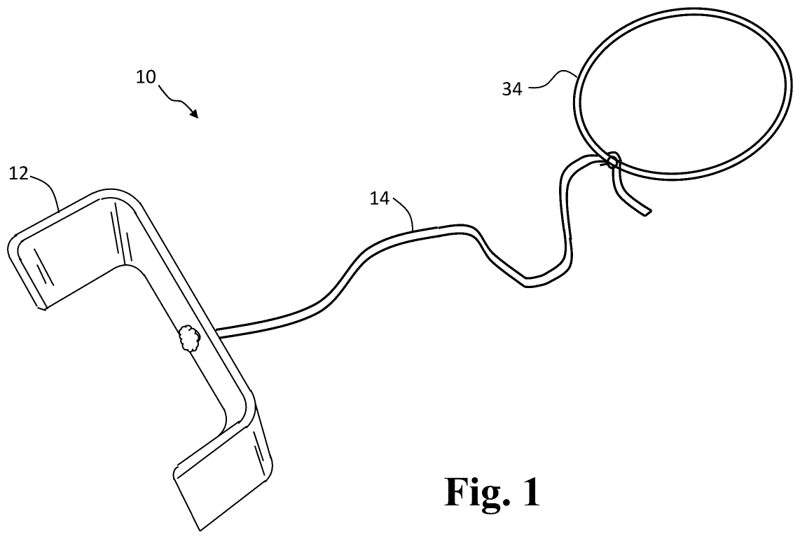

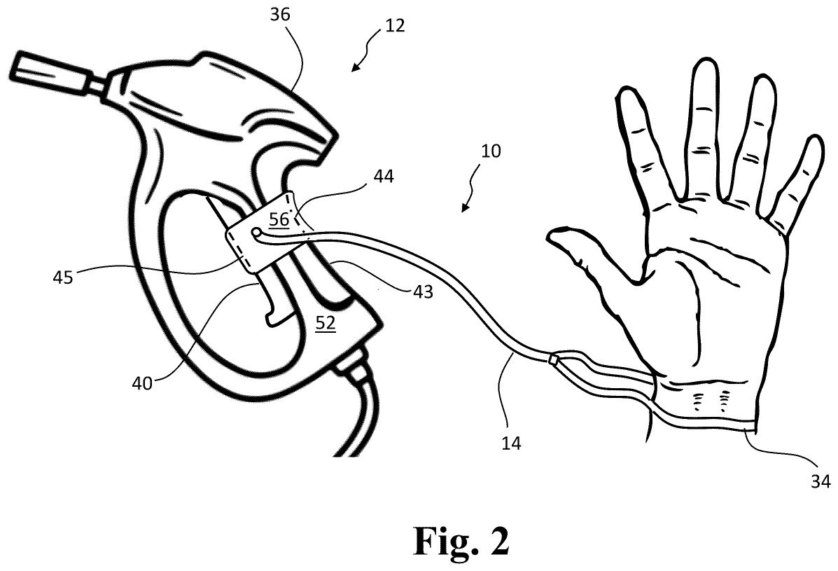

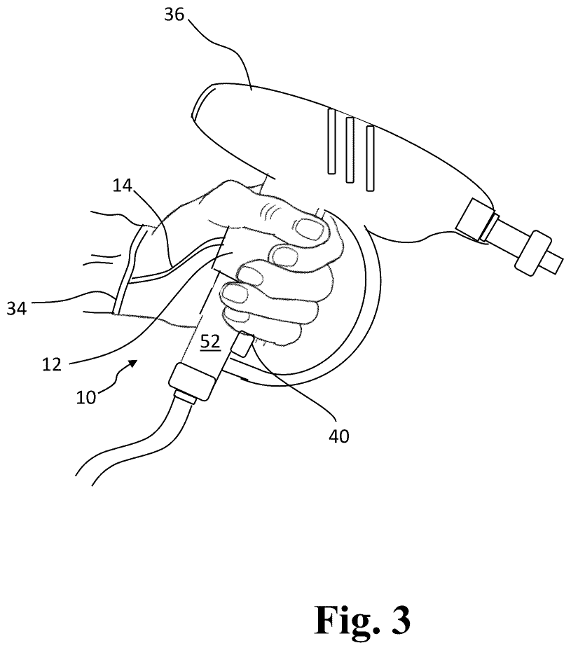

FIG. 1 is a perspective view of an exemplary embodiment of an attachment 10 including a clip 12 and a tether 14. In FIG. 2, the clip 12 is shown engaged with the handle 52 of a work tool's gun 36 (embodied in FIG. 2 as a power-washer gun) so that the clip 12 automatically holds the trigger 40 of the handle 52 in an on-position. In FIG. 2, a user's hand is shown inserted through a loop 34 of the tether 14. FIG. 3 shows the attachment 10 being used with a different type of work tool but related in that it also includes a handle 52 and trigger 40. In FIG. 3, the attachment 10 is again shown with the clip 12 engaged with the work tool's handle 52 so as to hold the trigger 40 in an on-position, but with the user comfortably grasping the work tool's handle 52 over the clip 12. In this disclosure, when referring to a clip that is engaged with a handle, the clip may sometimes be referred to as a handle-engaged clip.

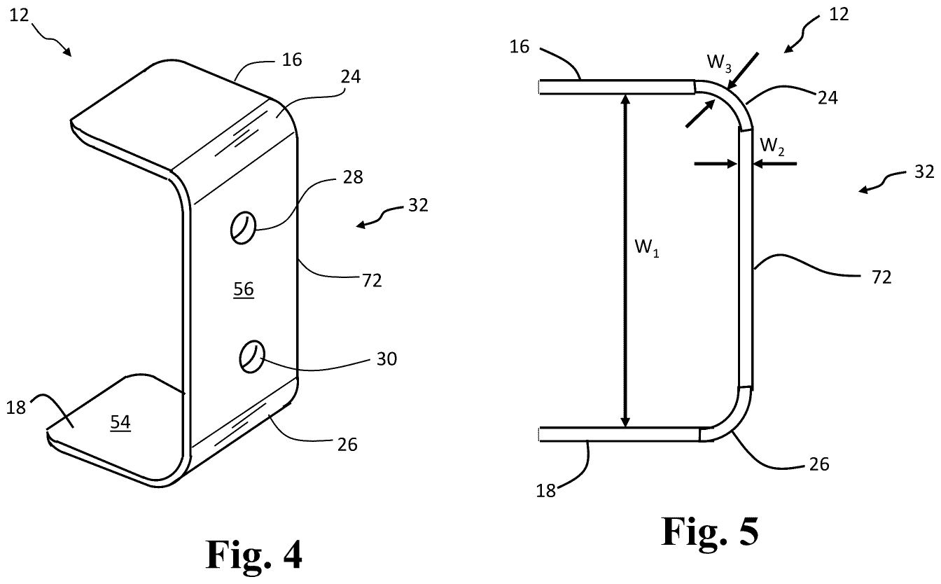

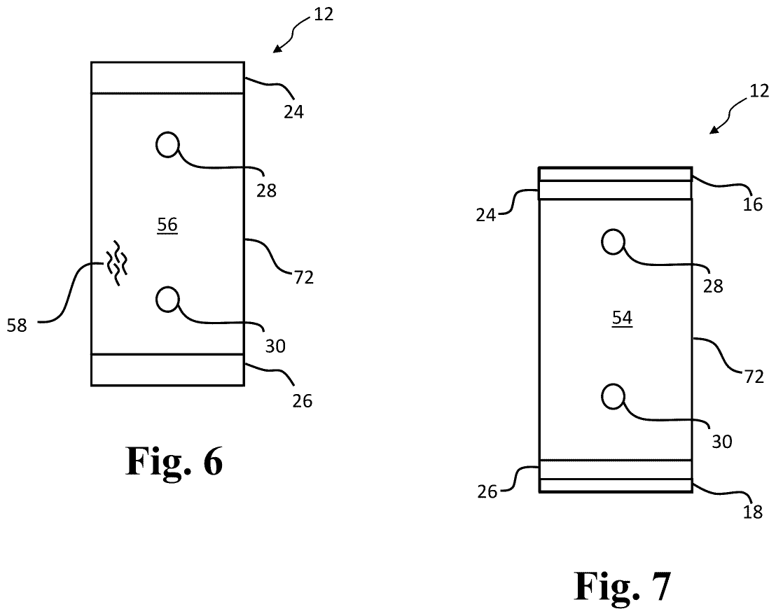

An exemplary embodiment of the clip 12 is shown in FIGS. 4-7. As shown therein, clip 12 may include a pair of arms 16, 18 extending from opposite ends of a link 32 (sometimes referred to herein as the middle section of the clip 12). In some embodiments, link 32 may include a central portion 72 and curved bends 24, 26. As shown in FIGS. 4-7, the central portion 72 of the link 32 may be substantially flat. However, in some embodiments, link 32 may be shaped differently. For example, in some embodiments, link 32 may be curved or shaped to generally follow the shape of a particular style of handle 52. In some embodiments, the link 32 may be shaped to provide a comfortable feel when a user is grasping a handle 52 of a work tool over the clip 12. As shown in FIGS. 4-7, a first arm 16 included among the pair of arms 16, 18 may be connected to the link 32 through a first curved bend 24. A second arm 18 included among the pair of arms 16, 18 may be connected to the link 32 through a second curved bend 26.

In some embodiments, clip 12 may be resilient or rigid. For example, link 32 (or one or more parts of the link 32) may be resilient so that it may deflect (e.g., bend or otherwise deform) under normal use conditions. Normal conditions of use may, for example, include application of forces when engaging the clip 12 with the handle 52 (e.g., when a worker is fitting the clip over the handle), and application of a biasing force provided by a trigger. Alternatively, the link 32 may be substantially rigid so that it generally maintains its shape under normal use conditions. In some embodiments, curved bends 24, 26 may comprise resilient parts of the link 32 that connect the central portion 72 of the link 32 to the arms 16, 18. A resilient link 32 may, for example, allow the clip 12 to be slightly deformed or bent when mounting the clip 12 to a work tool's handle. For example, the arms 16, 18 may be moved slightly away from each other when fitting the clip 12 over a handle 52 so as to position the clip 12 in a working or engaged position around the power-washer gun's handle 52 and its associated trigger 40. In some embodiments, the clip 12 may comprise resilient bends 24, 26 so that the arms 16, 18 may be moved slightly away from each other when a user mounts the clip 12 on the power-washer gun's handle 52 and its trigger 40. However, the clip 12 may still be configured to hold the trigger 40 in an on-position when the clip 12 is engaged over the work tool's handle 52 and its associated trigger 40, as shown in FIG. 2, for example.

In some embodiments, tether 14 may be secured to the clip 12. For example, as shown in FIGS. 4-7, the clip 12 may include one or more openings 28, 30 through which one end of the tether 14 may be inserted and secured, such as using a stopper knot, for example. Openings 28, 30 may be located such that tether 14 does not interfere with a user's grasp of the clip 12 about the handle 52. In some embodiments, the tether 14 may be secured to the clip 12 through one or more other suitable components such as a tie-down bracket, clamp, or fastener, for example. In some embodiments, the clip 12 may be configured so that the arms 16, 18 are spaced apart from each other so that the clip 12 may be positioned about the handle 52 and the trigger 40 when the trigger 40 is held in its on-position. For example, the width W1 may be dimensioned as appropriate so that one of the arms 16, 18 may abut against a surface 44 (see surface 44 shown as a dashed line in FIG. 2) of the handle 52 and the other of the arms 16, 18 may abut against a surface 45 (see surface 45 shown as a dashed line in FIG. 2) of the trigger 40 when the clip 12 is engaged with the handle 52 and the trigger 40 depressed to its on-position.

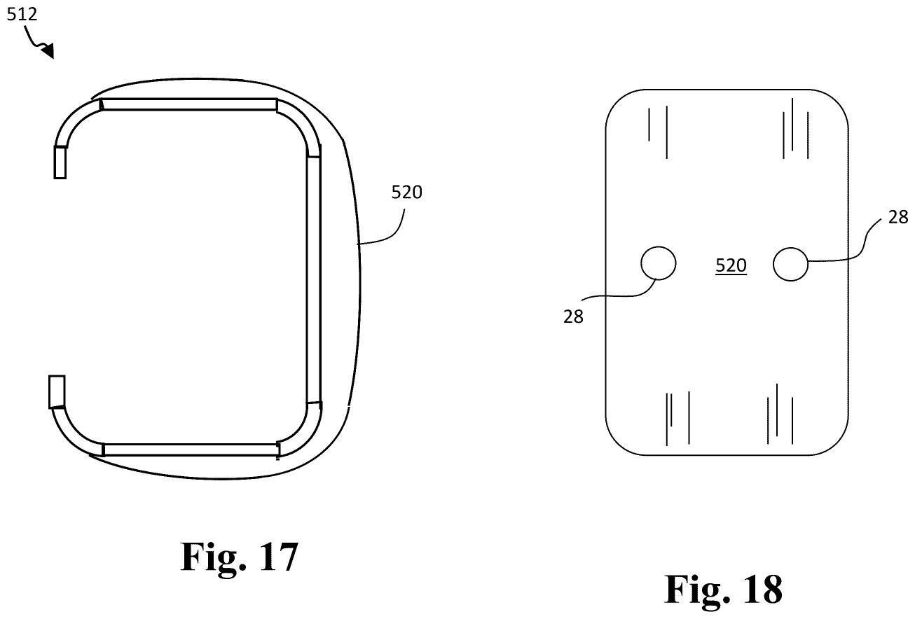

In some embodiments, the clip 12 may take the form of a plate or sheet of material bent or formed so as to provide a generally U-shaped or a generally C-shaped clip when observed in a side view. For example, the clip 12 may be made from sheet metal bent so as to provide a clip with a generally U-shaped profile or C-shaped profile. However, in some embodiments, the clip 12 may be made of plastic or some other suitable material such as may be molded or otherwise formed so as to provide a clip with a generally U-shaped profile or C-shaped profile. For example, as shown in FIG. 5, the clip 12 may have a generally U-shaped side profile. Alternatively, clip 12 may be made of a sheet of material bent or formed as a generally C-shaped clip when observed in a side view. For example, clip 12 may be shaped like exemplary clip 512 (shown in FIG. 17). As shown in FIG. 4, the clip 12 may be characterized as having a thin portion (e.g., characterized by a thickness or width W2 that is substantially less than the length of the U-shaped or C-shaped profile). With further reference to FIG. 2, the thin dimension of the clip may generally extend parallel to the surface of the handle 52 when the clip 12 is engaged with the handle 52. Accordingly, the clip 12 may protrude only a minimal distance from the handle 52. Accordingly, the clip 12 may provide an outer surface 56 that generally maintains the shape of the handle 52 so that workers may comfortably grasp around a handle-engaged clip 12. In some embodiments, the thickness of the clip 12, shown in FIG. 5 as the dimension W2, may be less than about 2.0 cm, less than about 1.0 cm, less than about 0.5 cm, or less than about 0.4 cm. In some embodiments, the width W2 may be between about 0.2 cm and about 2.0 cm, or between about 0.3 cm and about 1.0 cm. In some embodiments, a thickness of the clip 12 may be substantially uniform across the clip. In some embodiments, the thickness of the clip 12 may vary over different regions of the clip 12. For example, in some embodiments, the clip 12 may be characterized by a reduced width W3 at either or both of the curved bends 24, 26, for instance, to provide a desired degree of flexibility.

In some embodiments, the shape of a clip 12 may generally follow the profile of common handles for work tools. However, in some embodiments, the shape of the clip 12 may be configured differently. For example, the clip 12 may be shaped to contour a particular style of handle 52, or the clip 12 may be shaped to provide a comfortable feel when a user is grasping a handle 52 of a work tool over the clip 12. For example, some users of work tools may prefer a somewhat larger grip than commonly provided by a work tool, or a user of a work tool may prefer a custom-shaped grip that is different from a grip provided commonly by the handle of a work tool. Thus, in some embodiments, the clip 12 may be configured to minimize changes in the size and/or shape of a handle 52 so that a worker may comfortably grip around a handle-engaged clip (see FIG. 3). However, in some embodiments (see FIG. 17), the clip 12 may be purposefully configured to change a size and/or shape provided by a handle-engaged clip 12 about which a worker may more comfortably grasp when using a work tool.

In some embodiments, a plate or sheet of bent material forming the clip 12 may be substantially rigid so that it substantially holds its shape under conditions of normal use. For example, when the clip 12 is engaged with a power-washer gun's handle 52 (or other type of work tool) and its associated trigger 40, the clip 12 may hold its shape and provide the full force on the trigger 40 necessary to maintain the trigger 40 in its on-position. The clip 12 may protrude only a minimal distance from the handle 52 so that it does not interfere with the natural shape of the handle. For example, the exterior facing surface of the clip 12 may provide a grasping surface that generally matches the shape of the exterior surface 43 of the handle (see FIG. 2). Alternatively, the clip 12 may provide a grasping exterior surface (see exterior surface 520 shown in FIG. 17 and FIG. 18) that is somewhat different than that provided by the handle 52. In either case (see FIG. 3), a worker may grasp the handle around the clip 12 without adversely affecting hand feel.

In some embodiments, the clip 12 may comprise an outer surface 56 that may be smooth, textured, or shaped in a way that enhances comfort when a user is grasping around the handle 52 over a handle-engaged clip 12. In some embodiments, the outer surface 56 of the clip 12 may be configured the same or differently from an inner surface 54. Accordingly, in some embodiments, a user may grasp around the handle 52 (with the clip 12 coupled thereto and engaged with the trigger 40) without significantly impacting the feel of the handle 52, at least in any adverse way. For example, as shown in FIG. 3, a user may comfortably grasp the handle 52 with the clip 12 coupled thereto.

In some embodiments, outer surface 56 may include a textured component 58. Adding a textural component 58 to an outer surface 56 may improve comfort when a user is grasping a handle 52 around the clip 12. In some embodiments, the clip 12 may be coated or may include a rubber grip. In some embodiments, the clip 12 may be textured or otherwise configured so that a user is provided tactile feedback when they are grasping the handle 52 about the clip. In some embodiments, inner surface 54 may be configured so as to provide a generally low coefficient of friction between a handle 52 and the clip 12 and/or between the trigger 40 and the clip 12. This may, for example, help to ensure that the weight of a falling power-washer gun 36 (or other type of work equipment) would be sufficiently greater than a force necessary to free the clip 12 from the power-washer gun's handle 52 and trigger 40. This may be used in some embodiments not only to help ensure that the clip 12 readily disengages from the power-washer gun's handle 52 and trigger 40 should a user drop the power-washer gun 36, but also to minimize risk that the clip 12 might inadvertently catch on the power-washer gun's handle and/or trigger so as to inadvertently rotate the power-washer gun 36 and trigger 40 in a direction towards the face of the user, for example.

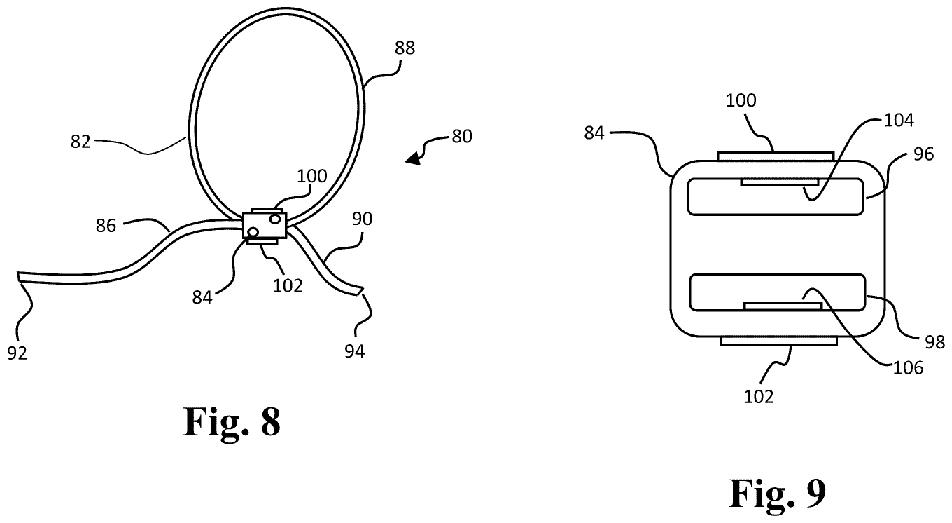

Another exemplary embodiment of a tether 80 is shown in FIG. 8. The tether 80 may, for example, be used in place of the tether 14 in the attachment 10 or used in some other attachment as described herein. As shown in FIG. 8, the tether 80 may include a strap 82 and an adjustable connector 84. In some embodiments, the strap 82 may include a continuous portion of material extending from a first end 92 to a second end 94. In some embodiments, the strap 82, may, for example, be made of nylon or neoprene. However, other appropriate materials may be used in some embodiments. The strap 82 may be overlapped over a portion of its length with overlapping regions of the strap 82 being secured in place with an adjustable connector 84. The adjustable connector 84 may, for example, comprise a connector, such as a ratchet-style connector or other suitable style of connector, including, for example, those of a type that allows for at least one of the overlapping portions of the strap 82 to be pulled through the connector 84 when a catch 104, 106 is released. Accordingly, using connector 84 or another suitable connector, a proportion of the strap 82 that is provided between a connecting portion 86, a loop portion 88, and a remaining portion 90 may be adjusted. For example, as shown in FIG. 9, the connector 84 may include a first cavity 96 and a second cavity 98. A catch 104 may be configured to reversibly engage with a portion of the strap 82 inserted through the first cavity 96 as may be controlled using a release 100, such as may be embodied in the form of a button, for example. Thus, by engaging the release 100, a user may pull a desired length of the strap 82 through the first cavity 96. Similarly, a catch 106 may be configured to reversibly engage with a portion of the strap 82 inserted through the second cavity 98. Engagement of the catch 106 with the strap 82 may be controlled using the release 102, for example.

The tether 80 may be adjustable so as to accommodate for different users and/or different grips. For example, a length of the connecting portion 86 may be adjusted so that the loop portion 88 may be drawn closer to or further from the first end 92. This may, for example, be done by releasing the catch 104 and sliding the strap 82 through the first cavity 96 so as to shorten the length of the connecting portion 86 of the strap 82. Likewise, the size of the loop portion 88 of the strap 82 may be adjusted by releasing the catch 106 and threading more or less of the strap 82 through the second cavity 98. Thus, the length of loop portion 88 may be adjusted so as to comfortably secure the loop portion 88 of the tether 80 around the relevant portion of a user's anatomy (e.g., the user's wrist, hand, or upper arm) as may be desired to accommodate different users. In some embodiments, the tether 80 may be provided or sold to a user in a form wherein the adjustable connector 84 is already connected to the strap 82. In some embodiments, the strap and adjustable connector may be provided as separate components. A user may, for example, be provided with instructions for securing the adjustable connector 84 to the strap 82 and/or for adjusting the tether 80.

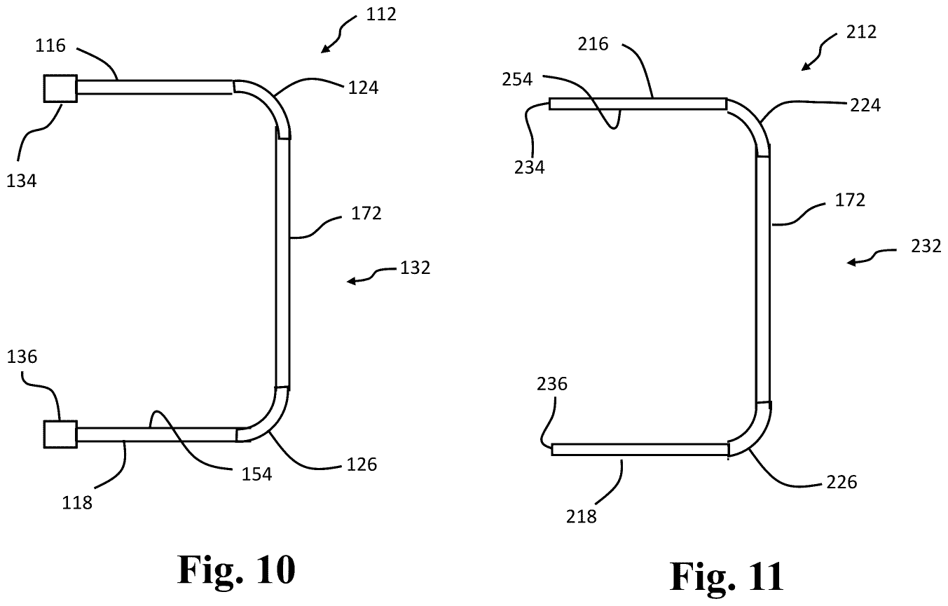

Another exemplary embodiment of a clip 112 is shown in FIG. 10. The clip 112 may include a pair of arms 116, 118 extending form opposite ends of a link 132. A first arm 116 included among the pair of arms 116, 118 is connected to the link 132 through a first curved bend 124 formed in the link 132. A second arm 118 is connected to the link 132 through a second curved bend 126 formed in the link 132. Link 132 may be comprised of a central portion 172, first curved bend 124, and second curved bend 126. Clip 112 may include a pair of nubs 134, 136. First nub 134 is disposed at a distal end of the arm 116. Second nub 136 is disposed at the distal end of the arm 118. In some embodiments, the nubs 134, 136 may help to hold the clip 112 in an engaged position around a work tool's handle 52 and its associated trigger 40 when the clip 112 is engaged therewith. In some embodiments, the nubs 134, 136 may not be so large as to prevent release of the clip 112 in the event that a user loses grasp of the work tool's handle 52.

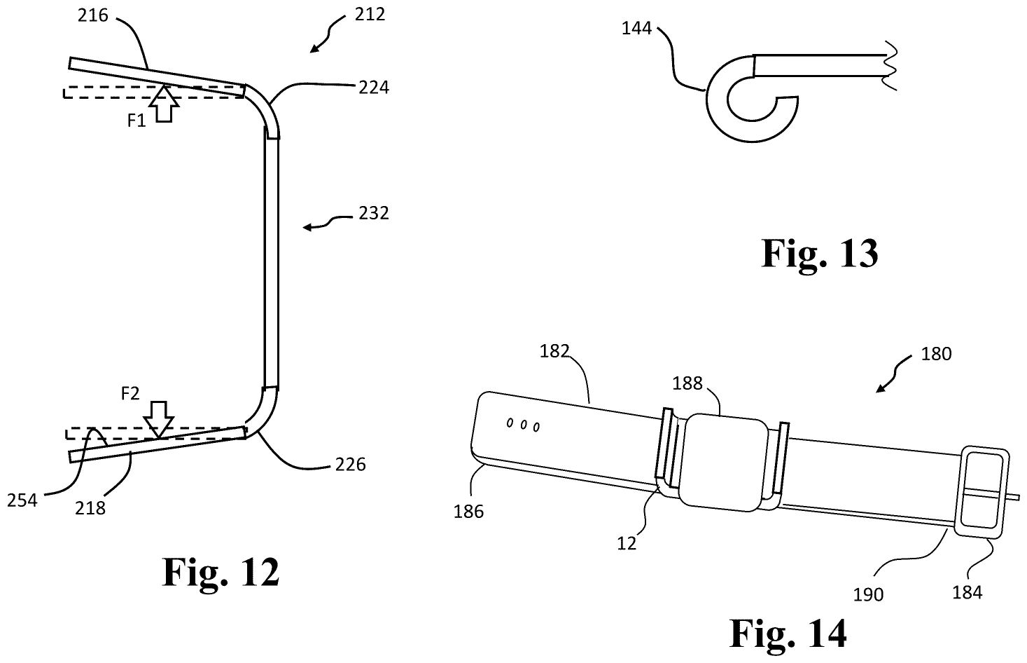

In some embodiments, nubs 134, 136 may help to hold the clip 112 in an engaged position around a work tool's handle 52 and associated trigger 40 when the clip 112 is engaged therewith and a user is grasping the handle 52 about the clip 112. The arms 116, 118 may be connected to the link 132 through resilient bends 124, 126. Resilient bends 124, 126 may be configured so that the arms 116, 118 are biased to become bowed outwards (as similarly shown for the clip 212 of FIG. 12) when a user is not helping to support the clip 112 by grasping the handle 52 over the handle-engaged clip 112. In this geometry (with the arms 116, 118 angled or bowed outwards), the clip 112 may disengage from or slide off of the handle 52 and its associated trigger 40. Thus, in some embodiments, a clip 112 may be configured to automatically disengage from a position engaging the trigger 40 when not supported by a user. Or, providing some resilience to the clip 112 may help to encourage ease of disengagement from a work tool's handle 52 so as to work with a tether 14, 80. Some such embodiments may be used without a supporting tether 14, 80. In other embodiments, a clip 112 may be used with a tether 14, 80. In some embodiments, a clip 112 may be substantially rigid so that it substantially keeps its shape during normal operation. For example, a tether 14, 80 may pull on a rigid clip 112 so as to allow for shut off of a work tool in the even that a user loses control of the work tool's handle.

In some embodiments, as shown in FIG. 10 for example, an inner surface 154 of the clip 112 may be materially composed, coated, or shaped so as to help facilitate disengagement of the clip 112 from the handle 52 when a user is not grasping the handle 52 about clip 112. For example, the inner surface 154 of the clip 112 may be made of a material that provides minimal friction when sliding over a handle 52, such as may commonly be made of plastic, for example. For example, a clip 112 may be made of or coated with polytetrafluoroethylene (PTFE) so that it will easily slide off from a plastic handle 52 should a user lose grasp of the handle 52 so that the user's hand is no longer supporting the clip 112 allowing it to bow and slide off from the plastic handle 52.

In some embodiments, a clip 12, 112, 212, 412 may be made from a flattened sheet of metal or other suitable material bent in a generally C-shaped or a generally U-shaped configuration. As shown in FIG. 13, one or more ends 144 of a clip 12, 112, 212, 412 may be folded or shaped. A folded end 144 may, for example, function in place of a nub 134, 136 (see FIG. 10) or together with a nub 134, 136 so as to help secure a clip 12, 112, 212, 412 to a work tool's handle 52. In some embodiments, a folded end 144 of a clip may not be so large as to prevent ready release of a clip 12, 112, 212, 412 when a user drops or otherwise loses control of the handle 52. In some embodiments, one or more bends 24, 26, 124, 126, 224, 226 of a clip may be resilient so that a clip 12, 112, 212, 412 may deform at least enough to prevent a folded end 144 or nub 134, 136 from keeping a clip 12, 112, 212, 412 secured about a work tool's handle 52.

Another exemplary embodiment of a clip 212 is shown in FIG. 11 and FIG. 12. The clip 212 may include a pair of arms 216, 218 extending from opposite ends of a link 232. A first arm 216 among the pair of arms 216, 218 is connected to the link 232 through a first curved bend 224 formed in the link 232. A second arm 218 is connected to the link 232 through a second curved bend 226 formed in the link 232. The curved bends 224, 226 may be resilient. For example, in the configuration shown in FIG. 12, the clip 212 includes resilient curved bends 224, 226 that may be distorted from their resting shape (e.g., indicated by a dashed line) due to forces F1 and F2 exerted on the clip 212 by the trigger 40 (not shown in FIG. 12). For example, the trigger 40 will be biased to an off-position so that it will apply a force (sometimes herein referred to as a biasing force or trigger applied force) so as to slightly deflect the clip 212, as illustrated. For example, some work tools including, for example, some power washers and some rotary-jack hammers may include a trigger 40 that demands a significant amount force to overcome the work tool's safety interlock. For example, the force necessary to overcome the bias force of the trigger may be significantly greater in some power washers or rotary-jack hammers than in a common spray gun.

When distorted in shape, the clip 212 may tend to slide off from or disengage from the work tool's handle 52. In some embodiments, a user may be required to supply at least some force so as to keep the clip 212 securely engaged with a work tool's handle 52. The force required by the user so as to keep the clip 212 securely engaged with the work tool's handle 52 (and its associated trigger 40) may be lessened by a force provided by the clip 212 due to the curved bends 224, 226 resistance to deformation. That is, a restoring force opposite in direction to F1 and F2 (shown in FIG. 12) may be supplied by the clip 212 on the trigger 40. In some embodiments, a user may only have to supply a significantly reduced amount of a force to maintain the trigger 40 in its on state when the clip 212 is engaged with the work tool's handle 52 and its associated trigger 40. That is, the amount of force necessary to keep the trigger 40 in its on state when using the clip 212 may be significantly reduced (e.g., reduced by about 20% to about 95%) as compared to a force the user would need to supply in the absence of the clip 212. In the absence of any additional force provided by the user (e.g., through engagement with a handle-engaged clip), the clip 212 may be configured to become distorted so that it tends to slide off from the handle 52 or otherwise disengage from a trigger 40. In some embodiments, an inner surface 254 of the clip 212 may be materially composed, coated, or shaped so as to help encourage ease of sliding of the clip 212 off of a work tool's handle and/or trigger.

In the particular embodiment shown in FIG. 11, the arms 216, 218 are shown substantially parallel to each other (and substantially normal to link 232) in the normal or relaxed configuration. However, in some embodiments, the arms 216, 218 may be differently configured. For example, in one example, distal ends 234, 236 of the arms 216, 218 may be angled slightly inwards toward each other so that the arms 216, 218 are slightly off parallel when the clip 212 is in its relaxed or unstrained configuration. In some embodiments, the arms 216, 218 may curl, at least to some extent, around the handle 52 as may, for example, be used to improve hand feel for a user grasping around a clip-engaged handle. For example, FIG. 16 shows another exemplary embodiment of a clip 412. The clip 412 includes an arm 416 including a bend 418 that may, at least in part, wrap around a handle 52 when the clip 412 is engaged therewith.

In some embodiments, an attachment for a work tool may include a clip 12, 112, 212, 412 integrated as part of a glove or strap that is configured to be secured to a user's hand. For example, FIG. 14 shows an exemplary embodiment of an attachment 180 including a clip 12 and a strap 182. The strap 182 may be configured for securing the clip 12 to the user's hand. In some embodiments, other clips 112, 212, 412 as described herein may be integrated as part of an attachment including the strap 182. As shown in FIG. 14, the clip 12 may be connected to the strap 182 using a pocket or sleeve 188. However, in some embodiments, the clip 12 may be fixedly secured or removably secured to the strap 182 using another suitable connector such as a clip or fastener, for example. The strap 182 may, for example, be wrapped around the hand of a user of a work tool so as to secure the clip 12 to the user's hand. In some embodiments, as shown in FIG. 14, the strap 182 may include a connector 184 at one end 190. The connector 184 may be configured to be secured to an opposite end 186 of the strap 182. In the illustrated embodiment, the connector 184 is embodied by a buckle. However, in some embodiments, other suitable connectors may be used. For example, the two ends 186, 190 of the strap 182 may be connected using a quick-release connector, a side-release buckle, or a stab-lock style buckle.

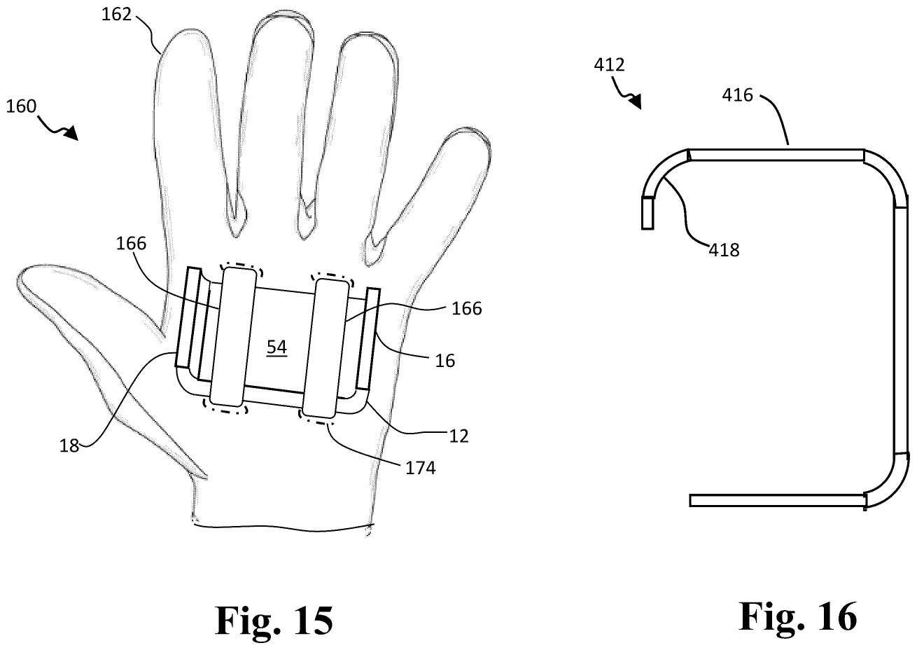

FIG. 15 shows another exemplary embodiment of a glove 160 configured for use with a work tool. As shown therein, in some embodiments, a clip 12, 112, 212, 412 may be integrated into or attached to the body 162 of the glove. For example, in the illustrated embodiment, clip 12 may be secured to glove 160 through one or more pockets or sleeves 166 such as may be sewn 174 to the glove 160. Of course, other connectors or means of attachment (e.g., stitching, rivets, adhesives, magnets, or a combination thereof) may be used to secure a clip 12, 112, 212, 412 to a glove 160. In some embodiments, an attachment for work equipment including a clip 12, 112, 212, 412 integrated as part of a glove or strap may be used with a tether 14, 80. In other embodiments, an attachment for work equipment including a clip 12, 112, 212, 412 integrated as part of a glove or strap may be used without a tether 14, 80.

In some embodiments, the shape of a clip 12, 112, 212, 412 may generally follow the profile of common handles for work tools. For example, a clip 12, 112, 212, 412 may comprise a generally C-shaped or U-shaped flattened plate or sheet that is configured to engage with a handle 52 and allow a user to comfortably grasp around a handle-engaged clip 12, 112, 212, 412. In some embodiments, a clip may be shaped to encourage a comfortable feel when a user is grasping a handle 52 of a work tool over the clip 12, 112, 212, 412. For example, some users of work tools may prefer a somewhat larger grip or a custom-shaped grip over a handle 52. In some embodiments, a clip 12, 112, 212, 412 may be purposefully configured to change a size and/or shape provided by a handle-engaged clip 12, 112, 212, 412 about which a worker may grasp when using a work tool. For example, as shown in FIG. 17 and FIG. 18, in some embodiments, a clip 512 may include an exterior surface 520 that may be shaped to purposefully alter the hand feel of the clip 512 or to size the handle for a worker's hand. For example, a clip 512 may slightly protrude outwards from the handle 52 so as to provide a larger gripping surface (exterior surface 520) for a worker with generally larger hands. In some embodiments, the clip 512 may change the general shape of a gripping surface 43 (see FIG. 2) so that the curvature of the gripping surface provided to a worker is changed. For example, the handle 52 may provide a profile with only slightly rounded corners. However, a handle-engaged clip 512 may provide a more rounded profile for grasping. In some embodiments, the exterior surface 520 of the clip 512 may, for example, be part of a rubber grip or grip made of some other material. In some embodiments, a kit of attachments may be sold including a plurality of clips of different shapes and styles so that a user may select a particular clip (e.g., one that includes an exterior surface 520 providing a specific hand feel) among the plurality of clips that is particularly suited for the user's anatomy and style of grasping the handle of a work tool and its associated trigger. A kit comprised of different clips may, for example, be provided along with a work tool (e.g., a power washer, rotary-jack hammer, or hand-held saw) so that a worker may choose an appropriate clip that is most comfortable for them. In some embodiments, clip 512 may include a surface 520 that is custom molded for a particular user's hand.

Although the foregoing specific details describe certain embodiments of this invention, persons of ordinary skill in the art will recognize that various changes may be made in the details of this invention without departing from the spirit and scope of the invention as defined in the appended claims and other claims that may be drawn to this invention and considering the doctrine of equivalents. Among other things, any feature described for one embodiment may be used in any other embodiment, and any feature described herein may be used independently or in combination with other features. For example, in an exemplary manner folds, 144 or nubs 134, 136 are conveniently described as parts of a specific clip. However, in some embodiments, other clips shown herein may include a fold, nub, or combination thereof. Also, unless the context indicates otherwise, it should be understood that when a component is described herein as being mounted or connected to another component, such mounting or connection may be direct with no intermediate components or indirect with one or more intermediate components. Therefore, it should be understood that this invention is not to be limited to the specific details shown and described herein.

What is claimed is:

1. An attachment for a work tool having a handle and a trigger adjustable between an on-position and an off-position, the attachment comprising:
a clip including a first arm and a second arm extending from a link, the clip being configured so that said first arm and said second arm delineate a width suitable for holding the trigger in its on-position, with the first arm abutted against an external surface of the handle and the second arm abutted against the trigger, when the clip is engaged with the handle; and
wherein the clip includes an exterior surface configured for manual grasping by a worker when the clip is engaged with the handle of the work tool.

2. The attachment of claim 1 wherein the clip has a generally C-shaped or a generally U-shaped profile.

3. The attachment of claim 2 wherein a thickness of the link is thin relative to a length along the profile.

4. The attachment of claim 3 wherein the thickness of the link is between about 0.2 cm and about 2.0 cm.

5. (canceled)

6. The attachment of claim 1 wherein the exterior surface of the clip is textured.

7. The attachment of claim 1 wherein the exterior surface of the clip is part of a rubber grip.

8. The attachment of claim 1 wherein the link comprises a shape that generally follows a shape of the handle.

9-12. (canceled)

13. The attachment of claim 1, the link comprising a first curved bend that connects to one of the first arm and the second arm.

14. (canceled)

15. The attachment of claim 13 wherein the first curved bend is resilient.

16. (canceled)

17. The attachment of claim 15 wherein the clip is configured to bend when subject to a biasing force provided by the trigger; and
wherein bending of the clip encourages disengagement of the clip from the handle.

18. The attachment of claim 17 wherein the clip is configured to automatically disengage from the handle when the clip is not grasped.

19-23. (canceled)

24. The attachment of claim 1 wherein the clip includes at least one of a nub and a fold at a distal end of at least one of said first arm and said second arm.

25. (canceled)

26. An attachment for a work tool having a handle and a trigger adjustable between an on-position and an off-position, the attachment comprising:
a clip comprising a generally C-shaped or generally U-shaped profile and a thin portion configured to wrap about at least a portion of the handle, the clip being configured for holding the trigger in its on-position when the clip is engaged with the handle, the thin portion characterized by a thickness that is substantially less than a length of the profile; and
wherein the clip includes an exterior surface configured for manual grasping by a worker when the clip is engaged with the handle of the work tool.

27. The attachment of claim 26 wherein the exterior surface of the clip has a shape that generally matches a shape of an exterior gripping surface of the handle.

28. The attachment of claim 26 wherein the clip includes a curved bend having a thickness less than the thickness of the thin portion.

29-40. (canceled)

41. The attachment of claim 26 further comprising a tether secured to the clip, the tether comprising a strap including a loop portion configured for securing the tether to a hand or a wrist of the worker.

42. The attachment of claim 41 wherein the tether further comprises an adjustable connector, the adjustable connector being configured for adjustment of each of a first length of said strap and a second length of said strap, the first length of said strap corresponding to said loop portion and the second length of said strap connecting the loop portion of said strap to said clip.

43-73. (canceled)

74. A work tool comprising:
a handle including a trigger for controlling an operational mode of a work tool, the trigger being adjustable between a first position and a second position; and
a clip including a first arm and a second arm extending from a link, the clip being configured so that said first arm and said second arm are separated by a width suitable for holding the trigger in its first position, with the first arm abutted against an external surface of the handle and the second arm abutted against the trigger, when the clip is engaged with the handle;
wherein the clip includes an exterior surface configured for manual grasping by a worker when the clip is engaged with the handle of the work tool.

75. The work tool of claim 74 wherein the trigger is operably engaged with a safety-interlock, said first position being an on-position for the work tool and said second position being an off-position for the work tool.

76. The work tool of claim 74 wherein the clip has a generally C-shaped or a generally U-shaped profile.

77-86. (canceled)
